(19) United States
(12) Patent Application Publication
(10) Pub. No.: US 2005/0166161 A1
(43) Pub. Date: Jul. 28, 2005

(54) User input system and method for selecting a file

(75) Inventor: Mikko K. Makela, Tampere (FI)

Correspondence Address: FOLEY & LARDNER, 321 NORTH CLARK STREET, SUITE 2800, CHICAGO, IL, 60610-4764, US

(73) Assignee: Nokia Corporation

(21) Appl. No.: 10/767,479

(22) Filed: Jan. 28, 2004

(51) Int. Cl. G06F 3/00

(52) U.S. Cl. 715/854; 715/850; 715/853; 715/712; 715/713; 715/734; 715/738; 715/739; 715/748

(57) ABSTRACT

A present invention relates to methods, devices, systems, and a computer program products for selecting files from a file list. The methods, devices, systems and computer program products are configured to provide more efficient ways for selecting a file from a file list in various usage scenarios.

### FIELD OF THE INVENTION

The present invention relates generally to the field of user interfaces. More particularly, the present invention relates to user input and file selection systems.

### BACKGROUND OF THE INVENTION

Conventional information and communication systems typically include graphical user interfaces (GUIs). GUIs can include a display device and a user input device. The display device can present a series of icons or menus which a user selects or manipulates with the user input device to provide user input. In many situations, the GUI provides lists of items allowing the user to select desired items using the user input device. For example, file lists can be used for locating files to upload or download from one device to another. Upon initiation of an upload or download command, the user is typically presented with a input box into which the user must specify the name and location of the file to be transferred. Because file folder/directory locations and names can be difficult to remember, a “browse” option is often provided in connection with the input box. The “browse” option allows the user to search through the storage medium of the device, typically on a folder-by-folder or directory-by-directory level. When a particular folder or directory is selected, a list of files located in that folder or directory is typically displayed. In this manner, the user can search through the storage medium and select the desired file for upload or download. Often times, a list of items presented by a GUI is too long to be displayed in one screen of information on the display device. In this situation, a scroll bar can be presented in connection with the list, allowing the user to scroll through the list to view list items which cannot be displayed on the initial screen of information.

The spread of electronics in everyday life has lead to the creation of smaller and smaller electronic devices with increasing interconnectivity with other electronic devices. These devices include wireless communication devices, for example mobile telephones, alphanumeric pagers, “palmtop” computers, personal digital assistants (PDAs), and other small form factor, primarily handheld communication and computing devices. Many electronic devices now support not only basic point-to-point communication functions like telephone calling, but also more advanced communications functions, such as electronic mail, facsimile receipt and transmission, Internet access and browsing of the World Wide Web including both uploading and downloading of information and the like. Generally, such wireless communication devices have software that is capable of managing the multitude of various handset functions and the telecommunications connections. In other word, these small form factor wireless communication devices can include many functions and features previously available in larger form factor communication and information systems.

Wireless communication devices have generally reached a very desirable and small form factor—the smaller size is more user friendly than the older bulkier devices allowing the user to easily carry the device. Despite their small form factor, users still demand that their wireless communication devices include many of the features and functions of larger, less mobile devices. Thus, the predominant area of improvement and often the area upon which marketplace success or failure depends lies in the device's feature set and especially in the ease of use of such features.

Much of the focus of small form factor electronic devices has involved increasing the interconnectivity between various devices especially with regard to the transfer of multimedia information. Another focus has been to standardize the user interfaces and capabilities of small form factor devices with those of “full-size” personal computers. However, wireless communication devices present a variety of more challenging design and implementation issues that do not arise with larger processor-based systems, such as notebook and desktop computers, which may also have similar telecommunication features. These design challenges include the design of the user interface, the customization of the devices for particular service operators, the integration of Internet and World Wide Web access with other communication functionality, and the software development process.

Underlying all of these design challenges are the restrictions placed upon a small form factor electronic device by the very nature of its small size. Unlike desktop and notebook computers, wireless communication devices require a small screen display size. Thus, the design of a wireless communication device must provide access to essentially the same features desktop computer users have become accustomed to, such as electronic mail, facsimiles, and Web browsing, yet with only a fraction of the screen area for displaying the requisite text, images, icons, etc. The difficulties are particularly significant when handling Web based content, since conventional Web content, such as forms and web-based user input systems, assume the larger screen size of conventional desktop computers and often inherently require a large display space. Such forms are difficult to see and use on the small screen of a wireless communication device.

Another restriction on small form factor electronic devices is the limited set of inputs available to the user. Conventional desktop or notebook computers have cursor based pointing devices, such as a computer mouse, trackball, joystick, or the like, as well as full-size keyboards with multiple hotkeys and function keys possible. This enables navigation of Web content by clicking and dragging of scroll bars, clicking of hypertext links, and keyboard tabbing between fields of forms, such as HTML forms. In fact, it is the desktop and notebook computer for which most web sites and Internet forms are designed. Wireless communication devices can sometimes be very limited in the types of input devices available. For example, some basic devices may be limited to up and down keys, and one to three softkeys.

Despite these restrictions and challenges, small form factor devices must operate in conjunction with the established framework of communications means, such as the Internet. The many standards governing the capturing, storage and transmission of multimedia data are widely accepted by manufactures of digital devices and are increasingly being incorporated into digital devices to allow for the viewing and sharing of multimedia data in multiple formats and versions. On the Internet, the hypertext markup language (HTML) and Synchronized Media Integration Language (SMIL) are common standards for representing multimedia content. HTML is a Standard Generalized Markup Language (SGML) based standard defined by the World Wide Web Consortium (W3C). HTML describes a Web page as a set of media objects, elements or resources, such as images, video, audio, and applications, together with a presentation structure.

A more recent version of HTML called EXtensible HyperText Markup Language (XHTML) is a functionally equivalent version of HTML that is based on EXtensible Markup Language (XML) rather than SGML. SMIL is an XML-based language for integrating different media resources such as images, video, audio, etc. into a single presentation. SMIL contains features that allow for referencing media resources and controlling their presentation including timing and layout. SMIL also includes features for linking to other presentations in order to create hypermedia presentations. SMIL is a composition language which does not define any representations for the media resources or objects used in a presentation. Instead, SMIL defines a set of tags that allow media objects or resources to be integrated together or composed into a single presentation. While some SMIL features exist in HTML, SMIL focuses on the spatial and temporal layout of media resources and provides greater control of interactivity than HTML.

In XHTML there is a possibility to add a file selector component similar to the “browse” feature described above. With the file selector component, the user can browse through the storage medium of his device and store files to a web service that provides such a file selector component. When the user clicks the “Browse . . . ” button of a file selector, the browser usually takes the user to the folder from where the user previously added a file. However the focus is always on the first file of the folder. If the user wishes to add many files from the same folder, the user has to separately select and add each file usually having to scroll down from the first file of the folder to the correct one. In cases where many files are being transferred, this method can quickly become irritating for the user.

One possible scenario involving file selection in a small form factor electronic device involves digital photos. For example, it is quite typical that a user takes many photos using a camera incorporated into a mobile communication device. Because storage space on the mobile communication device is typically quite small and the file size of digital photographs are typically large, it is helpful to allow the user to upload the digital photograph files to an external storage device such as a file storage service or the Internet. However, file selector components only support adding one file at a time. Thus, the user is forced to use the somewhat tedious process of uploading the files one by one.

Quite often a user would like to upload many files from a same folder or directory (maybe even the entire folder). As mentioned above, GUIs often help the user in this type of situation by configuring the “browse” command to open to the folder or directory from which the user last selected a file. For example, if the file the user previously uploaded came from the folder “My Pictures,” the next file selection dialog would automatically open to the “My Pictures” folder. In this case, a conventional GUI highlights the first file in the folder every time the folder is opened in response to a “browse” command. While this is not ideal, it is does not always create an insurmountable obstacle for a PC or other large platform device which often includes a pointing device (mouse or pen etc.) and a display big enough to display a long list of files from a folder in one screen of information. In this large platform system, selecting multiple files from the same folder can be done relatively quickly and without much scrolling of the display. However, on a small form factor electronic device, such as a mobile telephone, PDA, or mobile handheld computer, uploading multiple files from a folder can be less than convenient. Often times these mobile devices have a small display only capable of displaying a few files at the time. This may require the user to do quite a bit of scrolling through the list to locate files not displayed on the original display screen. Adding to the problem is the fact that many small platform mobile devices do not include a pointing device making scrolling much more difficult. Separately uploading multiple files from a folder can become very time consuming. For example, to upload all the files in a folder having 20 files could require up to 190 scroll events:
On the 2^{nd} file you would have to scroll down once,
On the 3^{nd} file you would have to scroll down twice,
On the 20^{th} file you would have to scroll down 19 times.

Thus, to transfer n files from a small platform device, it could require Σ(n-1) scrolls. Scrolling takes a considerable amount of time, has to be done carefully (if you scroll too fast you may skip the right file), requires much concentration, and forces the user to remember which file was added last so that the user can then scroll to the next file in the list. (Also note that on small displays there usually is not extra space available for showing the previously added file).

Accordingly, it is desirable to provide user input system and method for selecting a file that enables a user to have a more efficient, easier, and less burdensome file selection function.

### SUMMARY OF THE INVENTION

One embodiment of the invention relates to a system for selecting a file that enables the user to have a more efficient, easier, and less burdensome file selection function. If a user has already added a file from a certain folder and wishes to add another file from that same folder, the browser automatically highlights the next file after the previously added file instead of the first file of the folder.

This greatly reduces scrolling and thus adding multiple files from a folder is quicker and more intuitive. Also, if there are a lot of files, the user might easily forget which file should be added next since the display does not normally allow for the display of a list of previously added files. This is especially true for small form factor devices. With the present invention, the focus is always automatically on the next file to be added, thus avoiding this problem.

Other principle features and advantages of the invention will become apparent to those skilled in the art upon review of the following drawings, the detailed description, and the appended claims.

### BRIEF DESCRIPTION OF THE DRAWINGS

FIG. 1 depicts mobile telephone device having a display showing a file selection application having a “browse” function in accordance with an exemplary embodiment.

FIG. 2 depicts a personal digital assistant having a display showing a folder containing multiple files for uploading in accordance with an exemplary embodiment.

FIG. 3A depicts an exploded view of the folder containing multiple files for uploading of FIG. 2 having the first file in the folder selected in accordance with an exemplary embodiment.

FIG. 3B depicts an exploded view of the folder containing multiple files for uploading of FIG. 2 having the second file in the folder selected in accordance with an exemplary embodiment.

FIG. 4 is a flow diagram depicting file browse and selection operations in accordance with an exemplary embodiment.

FIG. 5 is a block diagram depicting a device in accordance with an exemplary embodiment.

### DETAILED DESCRIPTION OF THE PREFERRED EMBODIMENTS

In accordance with the present invention, a method, system, device and computer code product is described that provides distinct advantages when compared to those of the prior art. The invention can best be understood with reference to the accompanying drawing figures.

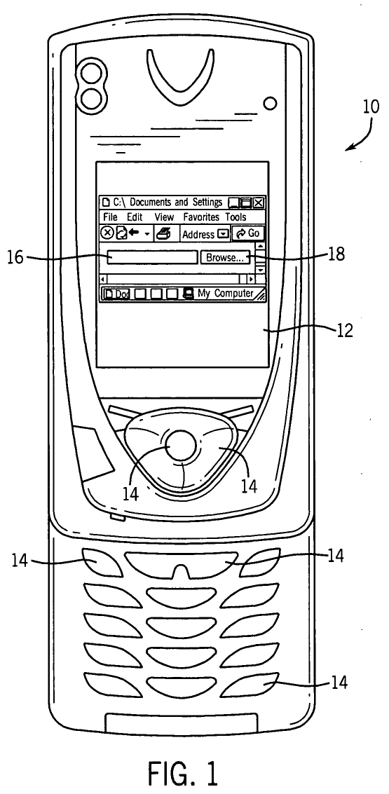

Referring now to the accompanying drawings, FIG. 1 illustrates one possible application of a user input system and method for selecting a file according to the present invention. FIG. 1 illustrates a mobile communication device 10 having a display screen 12, and user input controls 14. The display screen 12 provides a graphical user interface capable if displaying icons, menus, lists, etc. which the user can select by manipulating the user input controls 14. In this case, the display screen 12 is displaying an input box 16 of the type that can sometimes be presented to the user by a GUI in response to an upload or download command. The input box 16 includes a browse button 18 that can be activated to allow the user to search through the storage medium associated with the device 10. While upload and download commands are mentioned above, it should be noted that an input box 16 such as the one shown in FIG. 1 can be used in connection with any number of other commands and the invention described and claimed herein is not meant to be limited to only upload and download commands.

In one exemplary embodiment, XHTML can be utilized. Using XHTML, there is functionality to define a file selector component for a form. The file selector form can be defined for example as: <input type=“file”> (of course for submitting this must be inside a form element), which in Internet Explorer for Windows produced by Microsoft Corporation One Microsoft Way Redmond, Wash. 98052-6399 USA results in a display an input box 16 similar to the one shown in FIG. 1. By clicking the “Browse” button the user can select a file to be inserted to the box; the file would be shown inside the textual box on the left side of the button.

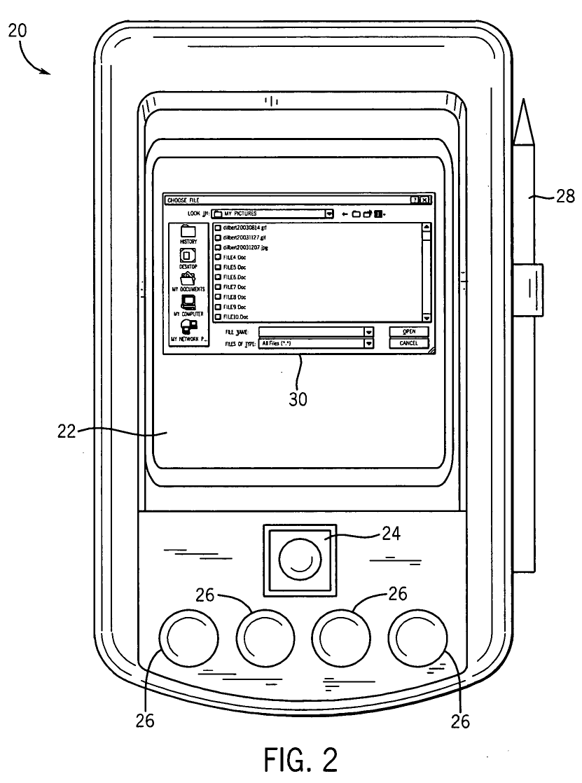

If the user activates the browse command by depressing the browse button 18, a file selection screen is displayed. FIG. 2 depicts another possible application of a user input system and method for selecting a file according to the present invention. FIG. 2 illustrates a PDA 20 having a display screen 22 and user input devices 24, 26, and 28. For example, user input device 24 can comprise a trackball type point device, user input device 26 can comprise configurable input buttons and user input device 28 can comprise a stylus which can be used with a touch screen display. The display screen 22 in FIG. 2 is showing the file selection screen 30 displayed in response activation of the browse command.

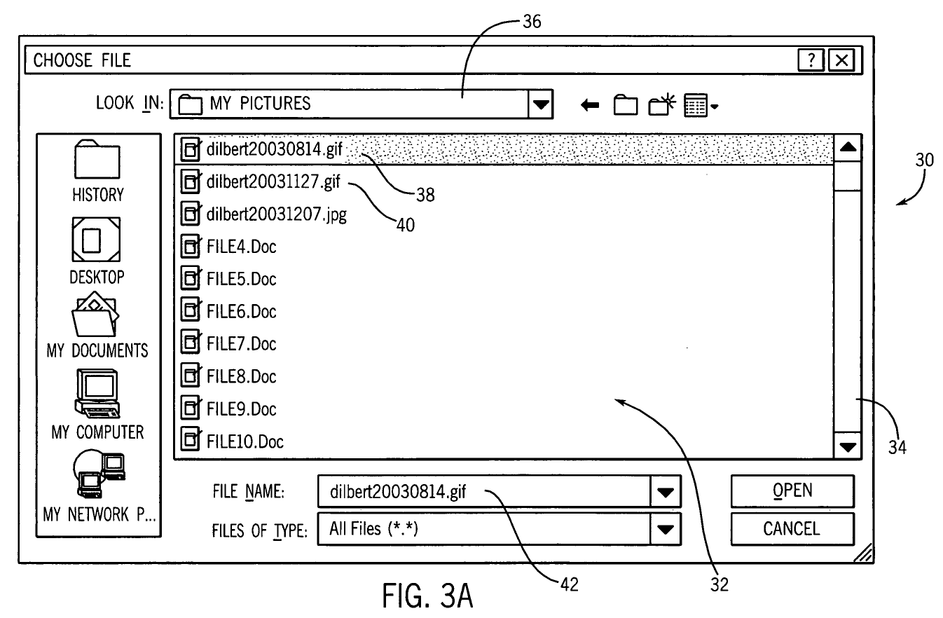

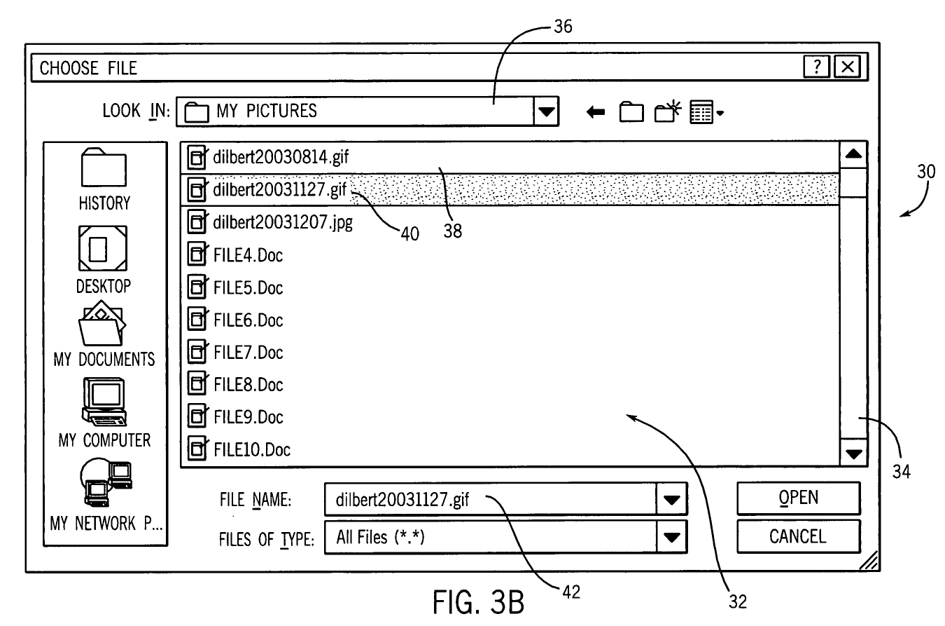

FIGS. 3A and 3B are an enlarged view of the file selection screen 30 displayed on the display screen 22 of FIG. 2. The file selection screen 30 can comprise a file list 32, a scroll bar 34, and a folder selection input box 36. Folder selection input box 36 can be used for selecting a folder or directory. Once a folder is selected, the file list 32 displays a list of the files located in the selected folder. The files names can be displayed in a predetermined order, such as alphabetically as shown in FIGS. 3A and 3B, with the first file 38 displayed at the top of the list, the second file 40 displayed second in the list, and so on. It is possible that the list of files in a selected folder will be too large to be displayed on a single file selection screen of information. In this case, the scroll bar 34 can be used to scroll through portions of the file list 32 not viewable in the original screen of information. The subject inventions has to do with the tracking of files and folders selected by the user and displaying and highlighting of folders and files in response to subsequent browse commands.

While the exemplary embodiment describes a single column list of files, it should be noted that the term “list of files” can encompass many different presentations of a group of files, folders, or data. For example, the files or folders can be arranged in a grid pattern, in a three-dimensional presentation, etc. The present invention is meant to include these various different presentation formats. In addition, the file list of the present invention is meant to include various other presentations of data, such as for example databases, or even non-visual data such as, for example voice-based data item selection systems.

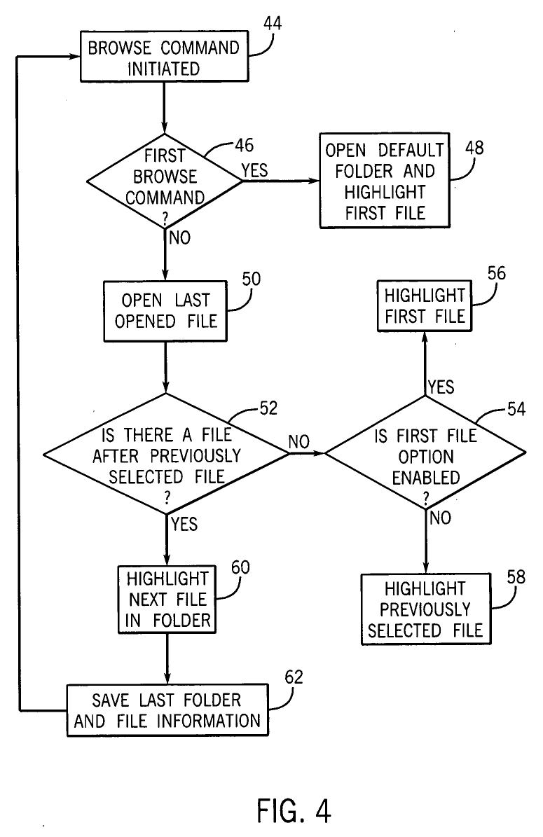

FIG. 4 is a flow diagram depicting browse and file selection operations in accordance with an exemplary embodiment of the present invention. In this exemplary embodiment, upon initiation of a browse command (step 44) the device 20 determines whether or not this is the first browse command initiated on the device 20 (step 46). If it is the first browse command, the device 20 opens file selection screen 30 and displays a predetermined default folder in the folder selection input box 36 and lists the files contained in the predetermined default folder in the file list 32 with the first file in the list 38 highlighted. If it is not first time the browse command is initiated, the device 20 determines which folder was selected in response to the last browse command and displays that folder in the folder selection input box 36 (step 50). The device then determines the file selected from the displayed folder in response to the last browse command and determines if there is another file listed after the last selected file in the file list 32 (step 52). If there is a file listed after the last selected file, the device 20 highlights this next file 40 in the file list 32 and waits for the user to select this or another file. After the user selects a file, the device saves the information pertaining to the last file selected and the folder from which it was selected (step 62) and waits for the next browse command to be initiated (step 44).

If there are no files listed after the last selected file in the file list 32, the device 20 determines if the first file option is enabled (step 54). If it is, the device displays the file list 32 with the first file 38 in the file list 32 highlighted (step 56). If the first file option is not enabled, the device 20 displays the file list 32 with the last file selected highlighted (step 58). Alternatively, if there is a folder on the list after the last selected file, the device can highlight the or even open the folder. Also, if there is neither a file nor folder after the last selected file, the device can refer back to the parent folder or directory of the folder, in which the last selected file resides and open the next folder in the parent folder list. In either case, after displaying the file list 32 and highlighting a file, the device 20 waits for the user to select this or another file. After the user selects a file, the device 20 saves the information pertaining to the last file selected and the folder from which it was selected (step 62) and waits for the next browse command to be initiated (step 44).

It should be noted that the above-described method can also be carried out on an application, as opposed to device, level. In other words, one application, such as Microsoft Word™, can track its last selected file, while another application, such as Microsoft Excel™, may track its own, different last selected file. In addition, default folders and settings can be different on an application level. A method according to the present invention can also be configured to highlight a predetermined file other than the folder after the last file selected in the list. For example, the method can be configured to highlight the file before the last selected file, the last selected file, the file to the left/right/up/down of the last selected file (such as in a grid display), the file in front of or behind the last selected file (such as in a 3D presentation), the next or previous page (if the list cover more than one screen full of information), or a file in some other position relative to the last selected file (such as the 2^{nd} file after or before, the 3^{rd} file after or before, etc.).

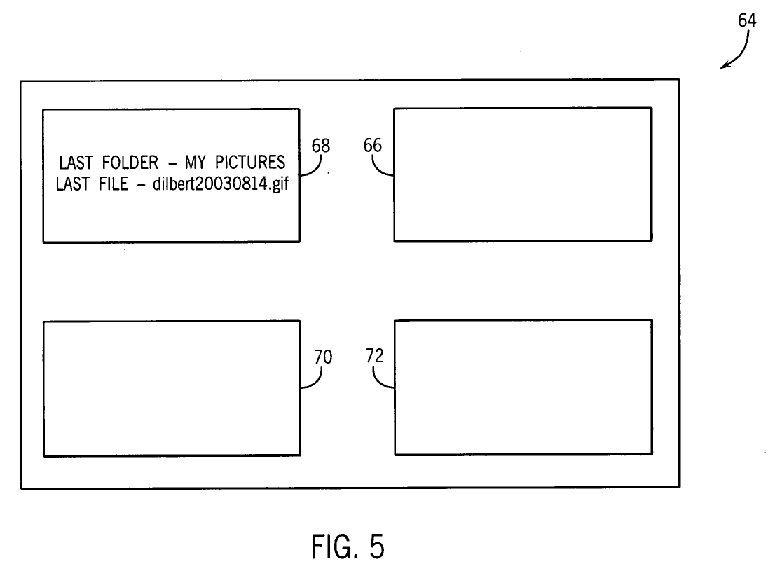

A block diagram of an exemplary embodiment of a device 64 in accordance with the present invention is depicted in FIG. 5. As shown in FIG. 5, one embodiment of a device 64 can include a display 66, memory 68, a storage medium 70, and a processor 72. The storage medium 70 can be configured to store information including files arranged in folders as described above. The processor 72 can be configured for controlling operation of the device 64 and the display 66 can be configured for displaying information including the input box 16 and file selection screen 30 described above. The memory 68 can be configured temporarily holding information, such as the last folder and last file information described above.

In one embodiment, folder and file name information can be stored in the memory 68 and used to determine which folder is selected and which file is highlighted in response to subsequent browse commands. In another embodiment, an indexing system can be used. In the indexing system, files should not be added, deleted, or renamed in a way that would disrupt the underlying index. The device 64 can be configured to remember the folder into which the last selected file belonged, and what the position of that file was in the folder, for example 1^{st}, 2^{nd}, 3^{rd}, n^{th}. When opening a file selection screen 30, the device 64 can open the folder into which the last selected file belonged, and put the focus onto (i.e. highlight) a file having one step bigger index than the last selected file (1^{st}+1, 2^{nd}+1, 3^{rd}+1, etc.). In case the previously selected file doe not exist anymore or cannot be found, the device 64 can for example revert back a default such as automatically highlighting the first file in the last selected folder or the first file in a default folder.

In one embodiment a system and method in accordance with the principles of the present invention may be used to add photos to a web service via a form on service's web page, for example using a mobile communication. The present invention provides a more efficient method for selecting a file in various usage scenarios. If the user was adding all the files from one folder to file selector boxes on a form, every time the user opens an empty file selector box (after the first file is added), the focus is automatically on the right file. If the user was adding not all but still multiple files from a same folder to file selector boxes, it is very likely that (s)he already browsed through files before the previously added file on a folder. In this case, the focus will automatically be placed on the next file and browsing can proceed logically from that point. If the user was randomly browsing through folders to find a couple of files to add, the focus would automatically be on the point from where it is very logical to continue browsing to find the next file to be added. If the user does not want to add any other file(s) from a same folder, this causes very little extra effort for the user. For example in many cases the GUI includes a “Back” softkey which allows the user to get back to a parent folder very easily.

Thus, system and methods in accordance with the principles of the present invention provide several benefits to a user including but not limited to:
If the user wants to add many files to a form, this invention makes the task a lot faster, and reduces memory load required from the user.
If the user is browsing though a file system and wishes to pick a few files to be added one by one, the invention supports this use by conveniently pointing to the location in which browsing was interrupted.
Does not require any additional input controls (buttons, menus, etc.) from a device.

While, the exemplary embodiments described herein relate to mobile communication device, it can readily be appreciated that the invention as described herein can operate equally well on less mobile devices such as laptop and desktop computers. The forgoing description of the invention outlines exemplary embodiments of a user input system and method for file selection. For purposes of explanation only, numerous specific details are set forth in order to provide a thorough understanding of the present invention. It is evident, however, to one skilled in the art that the exemplary embodiments may be practiced without these specific details. In other instances, structures and devices are shown in block diagram form in order to also further facilitate description of the exemplary embodiments.

While the exemplary embodiments illustrated in the Figures and described above are presently preferred, it should be understood that these embodiments are offered by way of example only. Other embodiments may include, for example, different techniques for performing the same operations. The invention is not limited to a particular embodiment, but extends to various modifications, combinations, and permutations that nevertheless fall within the scope and spirit of the appended claims as understood by one of ordinary skill in the art.

1. A method for selecting a file from a file list, the method comprising the steps of:
determining if there was a file previously selected from the file list;
determining if there is a next file listed relative to the previously selected file in the file list; and
displaying the file list with the next file highlighted.

2. The method of claim 1 wherein the next file is listed immediately after the previously selected file in the file list.

3. The method of claim 1 wherein the next file is listed a predetermined number of files after the previously selected file in the file list.

4. The method of claim 1 wherein the next file is listed immediately before the previously selected file in the file list.

5. The method of claim 1 wherein the next file is listed a predetermined number of files before the previously selected file in the file list.

6. The method of claim 1 wherein the next file is the file listed immediately to the left, right, up, or down of the previously selected file in the file list.

7. The method of claim 1 wherein the next file is the file listed a predetermined number of files to the left, right, up, or down of the previously selected file in the file list.

8. The method of claim 1 wherein the nect file is the file listed immediately in front of or behind the previously selected file in the file list.

9. The method of claim 1 wherein the next file is the file listed a predetermined number of files in front of or behind the previously selected file in the file list.

10. The method of claim 1 wherein the next file is a file listed on an immediately preceding or following screen full of information.

11. The method of claim 1 wherein the next file is the previously selected file in the file list.

12. The method of claim 1 further comprising the step of:
if there was not a file previously selected from the file list, displaying the file list with a predetermined default file highlighted

13. The method of claim 12 wherein the predetermined default file is the first file in the file list.

14. The method of claim 1 further comprising the step of:
if there is not a next file listed relative to the previously selected file in the file list, displaying the file list with a predetermined default file highlighted.

15. The method of claim 14 wherein the predetermined default file is the first file in the file list.

16. The method of claim 14 wherein the predetermined default file is the previously selected file from the file list.

17. The method of claim 1 further comprising the step of in response to a user selecting a file from a file list, saving the information identifying the selected file.

18. The method of claim 17 wherein the saved information is the file name of the selected file.

19. The method of claim 17 wherein the saved information is an index number of the selected file in the file list.

20. A user input system for selecting a file from a file list, the file list including a first file and at least one subsequent file, the user input system comprising:
a file selection screen for displaying files in the file list;
first means for determining if a file has been previously selected from the file list;
second means for determining if a next file is listed in relation to the previously selected file from a file list;
means for highlighting a predicted file of interest from the file list, the means for highlighting being configured to highlight the next file in relation to the previously selected file from a file list if one exists.

21. The user input system of claim 20 wherein the means for highlighting is configured to highlight the first file in the file list if the first means for determining determines that a file has not been previously selected from the file list.

22. The user input system of claim 20 wherein the means for highlighting is configured to highlight a default file in the file list if the second means for determining determines that there is not a next file in relation to the previously selected file from a file list.

23. The user input system of claim 20 wherein the default file is the first file in the file list.

24. The user input system of claim 20 wherein the default file is the previously selected file from the file list.

25. The user input system of claim 20 further comprising means for saving information identifying a selected file.

26. The user input system of claim 25 wherein the means for saving information saves a file name identifying the selected file.

27. The user input system of claim 25 wherein the means for saving information saves an index corresponding to the selected file in the file list.

28. The user input system of claim 20 wherein the next file is listed immediately after the previously selected file in the file list.

29. The user input system of claim 20 wherein the next file is the previously selected file in the file list.

30. A device configured for selecting files from a file list, the file list including a first file and at least one other file, the device comprising:
a storage medium configured for storing files which can be selected;
a display configured for displaying at least one file list;
memory configured for storing information identifying a previously selected file from the file list; and
a processor configured for identifying the previously selected file from the stored information, determining if a next file exists in relation to the previously selected file in the file list, and highlighting the next file, if one exists, in the file list displayed on the display.

31. The device of claim 30 wherein the processor is configured to highlight a default file in the file list if a next file does not exist.

32. The device of claim 31 wherein the default file comprises the first file in the file list.

33. The device of claim 31 wherein the default file comprises the previously selected file in the file list.

34. The device of claim 30 wherein the processor is configured to highlight the first file in the file list if it determines that a previously selected file does not exist.

35. The device of claim 30 wherein the next file is listed immediately after the previously selected file in the file list.

36. The device of claim 30 wherein the next file is the previously selected file in the file list.

37. The device of claim 30 wherein the device further comprises a mobile communication device.

38. The device of claim 30 wherein the device further comprises a mobile telephone.

39. The device of claim 30 wherein the device further comprises a personal digital assistant.

40. A computer program product for selecting a file from a file list, the file list including a first file and at least one other file, the computer program product comprising:
computer code configured to:
determine if there was a file previously selected from the file list;
determine if there is a next file listed in relation to the previously selected file in the file list; and
display the file list with the next file highlighted.

41. The computer code product of claim 40 further comprising computer code configured to display the file list with a predetermined default file highlighted if there is not a next file listed in relation to the previously selected file in the file list.

42. The computer code product of claim 41 wherein the predetermined default file is the first file in the file list.

43. The computer code product of claim 41 wherein the predetermined default file is the previously selected file from the file list.

44. The computer code product of claim 40 wherein the computer code is further configured to save information identifying a selected file in response to a user selecting a file from a file list.

45. The computer code product of claim 44 wherein the saved information is the file name of the selected file.

46. The computer code product of claim 44 wherein the saved information is index information of the selected file in the file list.

47. The computer code product of claim 40 wherein the next file is listed immediately after the previously selected file in the file list.

48. The computer code product of claim 40 wherein the next file is the previously selected file in the file list.
